(19) United States
(12) Patent Application Publication
(10) Pub. No.: US 2003/0069723 A1
(43) Pub. Date: Apr. 10, 2003

(54) System to integrate FPGA functions into a pipeline processing environment

(75) Inventor: Uday M. Hegde, Westford, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: DATACUBE, INC.

(21) Appl. No.: 10/190,437

(22) Filed: Jul. 3, 2002

Related U.S. Application Data
(60) Provisional application No. 60/302,786, filed on Jul. 3, 2001.

(51) Int. Cl. G06F 17/50; G06F 13/12

(52) U.S. Cl. 703/15; 703/20

(57) ABSTRACT

An integrated support tool set that allows a programmer to design an efficient pipelined FPGA.

### CROSS REFERENCE TO RELATED APPLICATIONS

This application claims priority under 35 U.S.C. §119(e) to provisional patent application serial No. 60/302,786 filed Jul. 3, 2001 the disclosure of which is hereby incorporated by reference.

### STATEMENT REGARDING FEDERALLY SPONSORED RESEARCH OR DEVELOPMENT

N/A

### BACKGROUND OF THE INVENTION

The present invention relates generally to development environments and, more specifically, to a development environment for producing a pipelined image processor based on semi-custom FPGAs.

Custom FPGAs are a common feature of high-performance data handling systems. The process of creating these custom FPGAs has evolved from the time when gates needed to be hand laid out to the use of VHDL (VHSIC Hardware Definition Language) or Verilog register transfer language, both industry standard register transfer descriptors, to specify the functions to be built within the FPGA. Further discussions herein will use VHDL in the discussion, although Verilog could be used. VHDL compilers use the VHDL description and an FPGA definition to generate a bit stream that is used at run time to personalize the FPGA.

While VHDL and other equivalent languages have become necessary in modern chip layout, there are other functions to be performed to realize a system using FPGAs. The process of defining the FPGA goes through the steps of turning an objective into a design, the design needs to be simulated, a test mechanism needs to be specified, the means of using the design must be documented and a program to accomplish the overall goal needs to be written. A number of vendors in the industry have created tools targeted at some of these tasks. Some of these vendors even offer facilities that support multiple parts of these tasks.

While the tools referenced above are useful when a single FPGA is being developed to function in an isolated environment, they do not address the complexities of integrating an FPGA into a more complex environment, such as a datastream environment. Typically that task has been left to the system designers who define such things as how variables are to be initialized, interfaces between discrete logic and the FPGA, and interfaces between the software and the functions performed by the FPGA. The complexities of these integration tasks are a limiting factor in the casual use of FPGAs.

Even more daunting are the complexities in developing a custom FPGA that must integrate with an already established FPGA environment having a set of conventions and rules. Each time one function is implemented in the FPGA, the auxiliary coordinating aspects of integration must be incorporated into the design. For the custom circuit designer, these additional design parameters increase the complexity of the design and the probability of error. If the additional functions are not well defined the entire system operation can be compromised and the likelihood that errors will slip through the simulation task and into the implemented chip increases.

Image processing systems handle large volume of data, in many cases performing the same operation on the data again and again. Such systems are well suited to using an FPGA programmed to perform the repeated operations. However, the image processing system is usually implemented using pipeline processing wherein the data is fed continuously in streams to logic operators that are expected to handle the streams. The data rates and pipeline systems increase the complexities of developing FPGAs for this application area.

### BRIEF SUMMARY OF THE INVENTION

In accordance with the present invention, an integrated support tool set is disclosed that enables a programmer to design an efficient pipelined field-programmable gate array (FPGA) to be mounted on a printed circuit board in a target system, such as an image processing system. The tool set includes a library of system operators having inputs and outputs, the operators tailored for pipeline operation, wherein the outputs of one operator are directly connectable to inputs of subsequent operators so that intermediate storage in a memory is avoided. The tool set further includes a set of programmed commands for interconnecting a set of operators to form a larger structure, such as a pipeline of processing operators to implement an image processing algorithm; a process that builds a pipeline model of the larger structure; an invokable hardware description language (HDL) process that generates an HDL description of some number of the pipeline models for the target FPGA, the HDL description being usable by an HDL compiler to generate a bitstream for programming the FPGA; and a synthesis process that builds a simulation of the larger structure for use in verifying the correct operation of the larger structure in the context of a set of system requirements. Other aspects, features, and advantages of the present invention are disclosed in the detailed description that follows.

### BRIEF DESCRIPTION OF THE SEVERAL VIEWS OF THE DRAWING

The invention will be understood from the following detailed description in conjunction with the drawings, of which:

FIG. 1 is a conceptual block diagram of the relationships among blocks in an environment according to the invention; and

FIG. 2 illustrates the logical organization of a board incorporating a semi-custom chip.

### DETAILED DESCRIPTION OF THE INVENTION

A system is disclosed that allows the development team and end-users of an image processing system to experience the run-time speed benefits of a custom pipelined system with the development efficiency of using an off-the-shelf system. A pipeline development environment (PDE) provides a high-level way of selecting and connecting image processing operators to address the image processing task. Further, PDE generates and maintains parallel instances of the solution that emphasize one particular aspect of it. This feature assures that the simulation environment, VHDL compiler, and run-time interface are always referencing the same model of the solution and so are synchronized.

The prior art has provided fairly general tools to solve general problems or a more specific set of tools targeted toward a particular implementation. It does not provide tools for the middle ground of supplying a general tool that gives the user freedom and yet produces a tailored specific implementation that conforms to a set of established design conventions. This system provides a designer with a well-defined interface for developing image processing algorithms that work within design conventions and the interface accommodates providing accessed to the capabilities offered by a specific implementation without changing operating procedures.

In developing a high-speed image processing system for an application such as web inspections in high volume manufacturing operations, hardware-implemented pipeline processing is needed to accommodate the volume of data that must be handled. The application must operate under the control of a master computer to coordinate control of the source of data (camera with product passing beneath the camera head), to set variables, and to provide the inspector with needed data. However, before an inspector can run the machine, someone has to design the process.

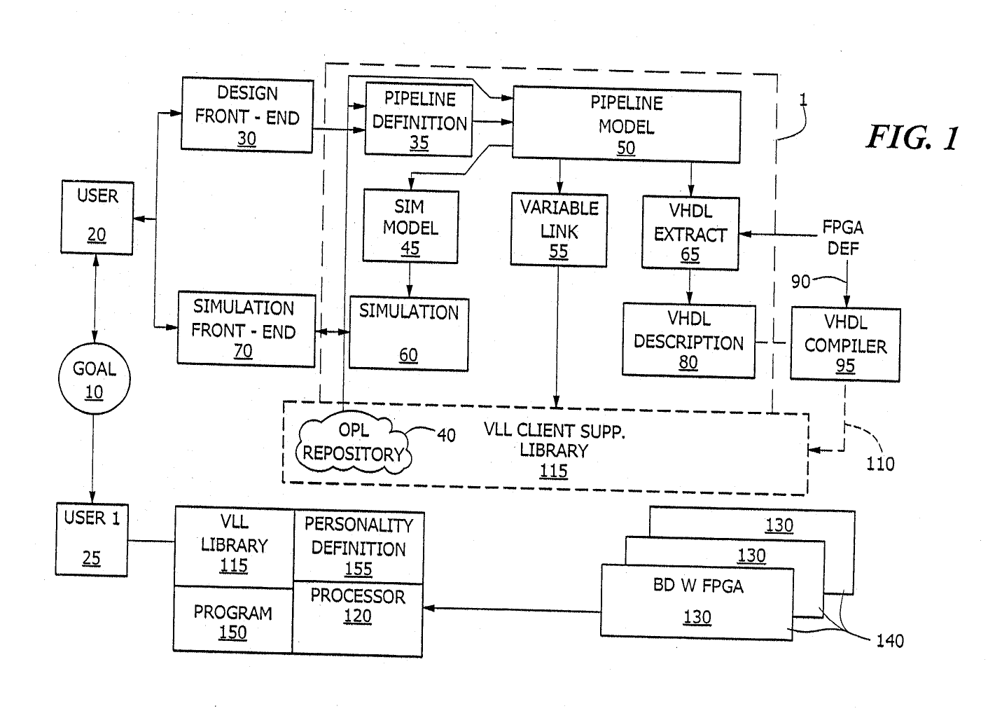

FIG. 1 is a block diagram of the PDE 1 showing its interface to users and other tools. The top interconnection of boxes represents the development environment. The bottom collection of boxes represent the run-time environment. The functions within dashed line box 1 are the PDE functions. The VLL Client Support Library holds the definitions used in the both the development and run-time environment.

In the development environment, an image processing task starts with the definition of a goal 10. The goal 10 is articulated in terms of the type of data to be analyzed, the equipment providing the data, the controls of that equipment, the processing that must be done on the incoming data, the result desired and the target hardware to be used.

A first user 20 is termed the process designer and is typically an image processing professional with some software dexterity. This first user 20 analyzes the goal 10 to determine what algorithms should be used to manipulate the data stream of the specified characteristics to “find defects” for example. The first user 20 breaks down the broad algorithms into a sequence of simpler algorithms to be performed on the data stream flowing in from the defined source. The algorithms are then organized into pipelines of operations on the data, where each unit of processing feeds the next and successive units of data are acted upon in sequence. Throughout this analysis phase, the process designer may view the design as a form of flowchart.

The first user 20 now must convert the conceptual pipelines into sequences of operations that can be executed in a run-time system. The pipeline definition utility 35 provides a simple interface (C++) to define a pipeline. A run-down of definitions: an algorithm is an entire sequence of operations the produce the goal result. An operation is an action that can be applied to a stream of data; operations get strung together. A pipeline is set of operations that has as its first operation retrieving data from a gateway and has as its last operation storing data through a gateway.

In FIG. 1, a utility—design front end 30 is available as an alternate way to define the pipeline. The design front end 30 is a graphical interface that allows the first user 20 to manipulate representations of the available operators graphically to build the pipelines. This allows the first user 20 to continue to visualize the operations acting on the data stream. The output of the design front end, is the same as if the first user had defined the pipeline using the simple interface of the pipeline definition utility 35. The real power in the design front end 30 is being able to visualize a set of functions that can be combined into a pipeline using a programming language such as C++. It is a productivity improvement to use the graphical user interface (GUI) that automatically builds the pipeline structure as the user manipulates the graphical representations of the available operators.

A depository 40 of definitions of the available operators for use by PDE 1 is associated with the Video Logic Library VLL 115. These definitions are used in both the development and runtime phases of the algorithm. There are two types of operators, system operators and composite operators. The system operators tend to be general operators needed for image processing. They are usually associated with hardware and are supplied by the hardware provider. The definition of each operator is multi-facetted—having a software definition, a hardware definition, a resource usage definition, and a run-time definition. As an operator is placed in a pipeline, the appropriate definition is accessed to align the effects of the individual operators. In this way, the resultant pipeline conforms to the established way of using and operating a system.

The definitions of the operators incorporate the constraints and conventions of the system so that the combinations of operators mesh well to form a whole. The definitions of operators cover such aspects as how run time variables are accessed, how the running operators stay synchronized with each other and what effect each operator has on simulation and on the VHDL description of the FPGA. The first user 20 does not have to be concerned with these aspects when connecting operators as the system is handling it.

The operator repository 40 presents only the system operators that are supported by the target hardware. Composite operators, assembled from supported system operators, are also present in the depository. The pipeline definition utility 35 is used connect operators. Some concatenations of operators are recognized by the user as more useful than others and so are stored in the repository 40 as composite operators. Once the first user has defined a custom reusable composite operator, it can be used, repeatedly, to build larger structures. The stringing together of operators, both system and composite, builds up a pipeline.

The pipeline model 50 holds the pipelines after they have been defined. The pipeline model breaks down the pipeline definition to the system operators and tracks how many clock cycles are required to execute each operator. The pipeline models 50 are the foundation for the remainder of the PDE.

To create a simulation of a pipeline, the simulation definition of the operators in that pipeline in the pipeline model 50 is processed to create a simulation 60 of the pipeline. The simulation 60 allows the first user 20 to examine the processing of an input data stream (not shown) to verify the how the pipeline is functioning. The user 20 can open ports to examine an internal data stream in the simulation for debugging purposes. A graphical simulation front end 70 allows the user 20 to set ports based on the graphical diagram of the pipeline, but is not a necessary part of the PDE. In debugging the simulated pipeline, the user works at the level of the functional structure in setting the ports and monitoring activity. The user does not have to understand the underlying pipeline model.

A comprehensive graphical user interface can mask the distinctions between the design front end 30 and the simulation front end 70 by integrating them into a whole. This capability improves efficiency by making it easier to iteratively modify the pipeline and see the results of the change, but does not add functions. All the functions can be performed by the set of simulation programming interfaces within PDE.

While in debugging mode, the user 20 shuttles between the design and simulation adjusting the functional structure and observing the effect of the adjustment on the simulation 60. Transparently, the pipeline definition utitlity 35 incorporates the adjustments into the pipeline model 50 and sets off the simulation generator 45 create an updated simulation 60 reflecting the changes in the pipeline model 50. The user 20 is prevented from changing the simulation directly, without a coordinated change in the pipeline model 50, thereby maintaining design integrity for the FPGA creation and run-time environment.

When the entire algorithm is complete and correct, the VHDL transform 65 is initiated. This transform uses the pipelines in the pipeline model 50 and a definition of the type of board with FPGA being used 90 to generate a VHDL definition of one or a number of programmed FPGAs. The user decides how many pipelines to place in one FPGA based on complexity and the board capabilities. Each VHDL description 80 is exported from the PDE 1 and applied in a stand-alone process to a VHDL compiler 100 that uses VHDL synthesis, place and route tools to finalize the selected FPGA. The VHDL compiler 100 outputs a data file called a bitstream 110. The bitstreams 110 are stored so they are accessible through the VLL API (Application Programming Interface).

One other output from the PDE 1 is the run-time variable access table. When the algorithm requires a run-time variable, the pipeline definition process defines a variable in the pipeline model. This variable is structured so that the processor, described below, can read and write the variable. As such, this model variable has a bus address, but the algorithm only knows the name assigned to the variable by the first user. When the run-time transform 55 create the run-time variable access table, it associates each variable name with its bus address.

As the first user 20, is building and verifying the functional structure, a second user 25, who is more oriented toward the application design, is developing an application program to control the system, usually in C++. As the first user 20 defines a pipeline, they can pass it along to the second user 25. Second user 25 builds a program to realize the goals of the process. This program uses calls to a library of image-data gathering and processing calls (VLL, a C++ compatible API functional library), messages between processors if necessary and VLL calls to the FPGA interface to program a fully designed and operational image analysis program. The image processing parts of the process are easily accessed by the calls to the VLL C++ API.

The run-time section of FIG. 1 shows a processor 120 that executes the image analysis program 150. The image analysis program 150, VLL library, and files that define the personality of the system reside on a processor 120. When the image analysis program 150 requires more than one processor 120, a host processor controls the system. The image analysis program runs in an environment of at least one processor 120 with at least one, but most likely many, image processing boards 130 mounted into it. The processor 120 is further connected to real-time interfaces that control things like cameras, conveyor belts, encoders, etc. (not shown). An image data stream 140 comes into the system, is appropriately broken up and delivered to the image processing boards. The image processing boards 130, discussed more fully below, consist of at least interfaces between the FPGA and the processor bus and image data stream manipulation logic. Before start-up, the FPGAs on the boards 130 are all unprogrammed.

The image analysis program 150 has three phases, start-up, run-time and idle. Start-up begins when the program is first invoked and involves many real-time equipment start-up operations and initialization of the image processing boards 130. When an image processing board 130 is initialized, the FPGA is fed its bitstream 110. The bitstream 110 transforms the inert FPGA into an FPGA that has a personality, and in particular, the personality conforming to its part of the pipeline model 50.

The run-time phase of the image analysis program 150 starts when the program lets data start flowing into the image processing boards 130. This phase lasts until all results are produced or an event, planned or unplanned, stops valid data transfer. The program 150 goes to an idle state from the run-time state, where idle means that the program 150 is checking whether valid data is available or the system is ready to restart.

The PDE 1 is continually updating the pipeline models 50 as the first user 20 and application developer 25 are designing the process. This implies that it is reasonable to create a VHDL description 80 of the current state of the pipeline models for an FPGA at any time. Therefore, when the application developer 25 is ready to test parts of the system that use the FPGA, a bitstream 110 of the currently known state of the FPGA can be created, and the VLL command to load the bitstream 100 can be invoked. There is no need to build artificial FPGA code for debug purposes.

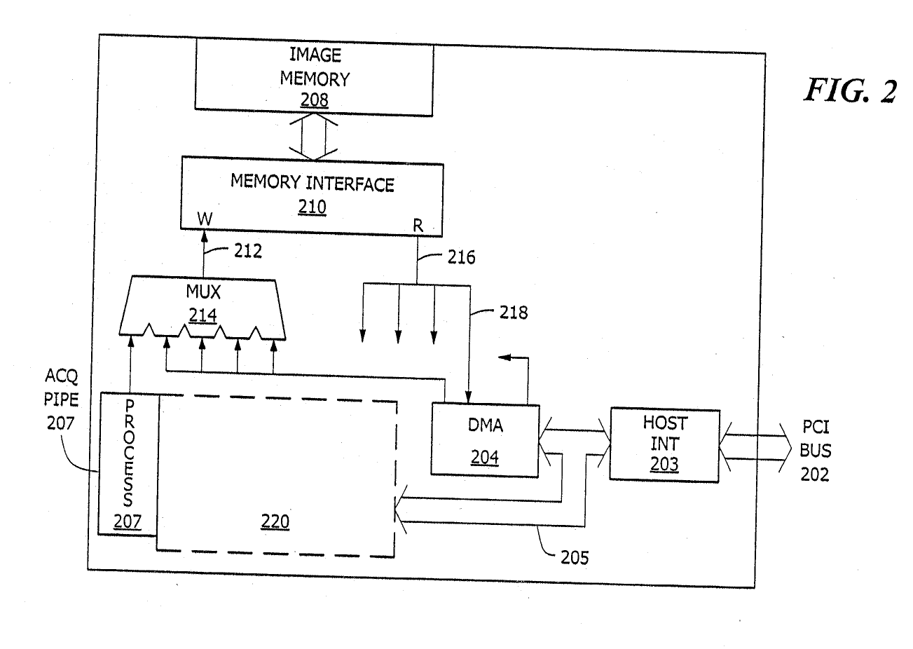

In order to provide powerful system operators to build from, the boards 130 that can be used in the processor have some defined functions implemented on the boards. Each type of board has a different set of functions and so the operators available depend on the board 130 being used in the implementation. Each board 130 has a block diagram similar to the one shown in FIG. 2. In FIG. 2, there are a number of defined elements such as the image memory or memory interface that are implemented discretely. Some other elements may be implemented in the FPGA. Some of the blocks shown in FIG. 2 are discretely implemented, but many of them are implemented in the FPGA (limits not shown). The FPGA on each board is broken into two parts, the static part and the custom or programmable part 220. The static part (can be anything but item 220 in FIG. 2) is the part defined by the board definition. The board implemented operator repository 40 starts with the operators supported by representation of the static part and is expanded as the user manipulates the system operators to form the functional structure. The model of the custom part 220 of the FPGA melds with the model of the static part to form a model of the whole FPGA that is programmed at start up.

The form of the implementation of the custom part depends on the board being used. If two boards that could be used in an implementation had common operators plus each had unique operators, and the user implemented the functional structure using only the common operators, the VHDL definition generated for each of the custom portions of the FPGAs would be different. It's as if each static part of an FPGA definition has it's own cavity that can be filled only by a unique plug. The transform from the pipeline model 50 to the VHDL description 80 handles this complexity.

Without regard to implementation, the board has a host interface 205 to the processor bus 202 for loading variables and reading registers on the board. There is also a direct memory access (DMA) port 204 that uses the host interface 205 to transfer data between the board and the processor for block transfers to the memory 208, for instance. The host interface and DMA port are also routed to the FPGA on the board. Depending on the board, the static part of the FPGA may manipulate the interface and port and the custom part 220 may also manipulate them. The boards have access to data acquisition pipe 206 where the data coming through the pipe can be pre-processed by system operators 207 or by the custom FPGA programming 220.

Each board also has a multiplexing structure 214 that drives a write port 212 into an image memory 208. A demultiplexing structure 218 connects to a read port 216 from the image memory. The connections that personalize the multiplexing and demultiplexing structures result from the functional structure that defines the programming of the custom FPGA.

The process of translating an image processing task into an executable program plus the creation of tailored components that execute an image processing algorithm is complex and has many steps. By handling the accounting for the variables with the pipeline model, PDE protects the developer from having to consider the hardware implications of the algorithm. Much of the development can be reused in subsequent projects even when a different hardware implementation is used. By basing all outputs of the development on the single pipeline models, each of the development products is synchronized to the others and can be used in a complementary manner.

Having described preferred embodiments of the invention it will now become apparent to those of ordinary skill in the art that other embodiments incorporating these concepts may be used. Accordingly, it is submitted that the invention should not be limited by the described embodiments but rather should only be limited by the spirit and scope of the appended claims.

What is claimed is:

1. An integrated support tool set that allows a programmer to design an efficient pipelined FPGA, the support tool set comprising:
a plurality of system operators having inputs and outputs, the operators tailored for pipeline operation, outputs of a first operator connectable directly to inputs of subsequent operators, avoiding intermediate storage in a memory;
a set of programmed commands for interconnecting a set of operators to form a larger structure;
an on-going process that builds an pipeline model of the larger structure;
an invokable VHDL process that generates a VHDL description of the FPGA portion of the pipeline model for a target FPGA chip mounted on a preselected board type, the VHDL description usable by a VHDL compiler to generate a FPGA programming bitstream;
an on-going synthesis process that builds a simulation of the larger structure for use in determining whether the larger structure is operating to meet a stated goal.
